(19) United States
(12) Patent Application Publication
(10) Pub. No.: US 2025/0115766 A1
(43) Pub. Date: Apr. 10, 2025

(54) Methods of Producing Carbon Blacks from Low-Yielding Feedstocks and Products Made from Same Utilizing Plasma or Electrically Heated Processes

(71) Applicant: Cabot Corporation, Boston, MA (US)

(72) Inventors: David M. Matheu, Somerville, MA (US); Geoffrey D. Moeser, Groton, MA (US); Theis F. Clarke, Houston, TX (US); Thomas E. McElwain, Pampa, TX (US); David S. Crocker, Townsend, TN (US); Akshay Gopan, Somerville, MA (US); Frederick H. Rumpf, Billerica, MA (US); William M. Porteous, N. Andover, MA (US)

(21) Appl. No.: 18/833,304

(22) PCT Filed: Jan. 18, 2023
(86) PCT No.: PCT/US2023/060805

§ 371 Date: Jul. 25, 2024

Related U.S. Application Data
(60) Provisional application No. 63/304,098, filed on Jan. 28, 2022.
(60) Provisional application No. 63/323,343, filed on Mar. 24, 2022.

(51) Int. Cl. C09C 1/48

(52) U.S. Cl. CPC C09C 1/482; C09C 1/48

(57) ABSTRACT

Methods to produce carbon black from low-yielding carbon black feedstocks are described using a process that involves the use of electrical energy to cause formation of carbon black from a carbon black feedstock(s). Carbon blacks produced from these carbon black feedstocks are further described. The advantages achieved with the methods are further described.

The present invention relates to methods of producing carbon black produced from alternative carbon black yielding feedstocks, which in many cases can comprise gaseous and/or low-yielding feedstocks. More specifically, the present invention relates to methods to produce carbon blacks that utilize plasma or electrically heated processes. The present invention further relates to carbon blacks formed from alternative carbon black yielding feedstocks that include gaseous and/or low-yielding carbon black feedstocks.

Carbon black has been used to modify the mechanical, electrical, and optical properties in compositions. Carbon blacks and other fillers have been utilized as pigments, fillers, and/or reinforcing agents in the compounding and preparation of compositions used in rubber, plastic, paper or textile applications. The properties of the carbon black or other fillers are important factors in determining various performance characteristics of these compositions. Important uses of elastomeric compositions relate to the manufacture of tires and additional ingredients often are added to impart specific properties to the finished product or its components. Carbon blacks have been used to modify functional properties, electrical conductivity, rheology, surface properties, viscosity, appearances and other properties in elastomeric compositions and other types of compositions.

The conventional and most common process for industrial production of carbon blacks is the furnace process. In this process, a first liquid carbon-bearing feedstock, such as decant oil, is injected into a fuel-lean hot combusted or combusting gas stream. Some of the feedstock pyrolyzes to make carbon black and byproducts (mostly hydrogen); the rest oxidizes to make CO, CO₂, and H₂O. The conventional or traditional feedstock is decant oil, slurry oil, coker oil, a coal tar derivative, or a heavy liquid residue from an ethylene cracker process. These carbon black feedstocks are simultaneously heavy (specific gravity >1.02), have an atomic H:C ratio of at most 1.23, are rich in aromatics (Bureau of Mines Correlation Index (BMCI)≥100), and are liquids at room temperature and pressure (e.g., 25° C. at 1 atm). They are all generally derived from fossil fuels.

Electrically-heated carbon black processes are alternative to the furnace carbon black process such as described in U.S. Pat. No. 1,536,612. In these processes, electricity is used to provide some or all of the energy required to drive the fast, high-temperature pyrolysis of a carbon-bearing feedstock into carbon black particles and byproduct gases. This is in contrast with the furnace process in which partial combustion of a fuel provides this energy. The burned gases are either produced within or mixed directly with the carbon-bearing feedstock to drive its pyrolysis to carbon black. Though the furnace process dominates commercial production of carbon black, an electrically-driven process offers one or more potential advantages over the furnace process.

An electrically driven process can use renewable electricity, instead of fossil-fuel combustion, giving this process a substantially lower greenhouse gas footprint compared to the furnace process. Electrically-driven processes can have a greater yield of carbon black per unit of feedstock consumed, saving operating costs, compared to the furnace process. The use of electrical energy to supply much or all of the needed energy to drive pyrolysis can enable more control over the gas-phase chemical environment in which the carbon black forms. As the energy need not come completely from combustion, the chemical environment during particle formation can be made more reducing (as opposed to oxidizing). This provides an additional method to control the final surface chemistry of the particles.

Electrically-heated carbon black processes tend to use natural gas, ethane, or similar gas-phase carbon-bearing feedstocks as the feedstock for carbon black production, as described for instance in U.S. Pat. No. 10,100,200. A disadvantage of these gas-phase feedstocks is their tendency to produce a very low structure for a given surface area. This structure can be too low to meet the requirements of ASTM grades for rubber reinforcement.

A further disadvantage of electrically-heated carbon black processes is that they use a carrier gas. This is done because the direct exposure of hot, actively heated surfaces, such as those produced at electrodes, to a carbon bearing feedstock, can result in rapid coke formation and severe operability problems. Furthermore, many electrode materials may be corroded away in service by hydrocarbon gases at high temperature.

The use of a carrier gas, such as hydrogen, or argon, solves these two problems, but introduces another problem: the volume of the carrier gas must be large compared to the volume of the feedstock. As high temperatures are required to produce suitable surface areas in an aerosol-based carbon black process, this means that more and more carrier gas must be used, relative to the amount of feedstock, as the required product surface area increases. Increasing carrier gas volume greatly increases capital costs.

It would be both economically useful and environmentally beneficial to use gaseous, renewable, recycled, and/or sustainable low-yielding feedstocks in an existing carbon black process. These feedstocks would not necessarily be fossil-fuel-based. Examples of these include ethylene, which can be produced from ethane cracking or from bio-ethanol. Another example is natural gas, which can be fossil-based or produced from landfills or the decay of organic matter. Further examples include vegetable oil, oils derived from the pyrolysis of recycled tires, plastics, municipal waste, or biomass, or natural gas produced from landfills.

Unfortunately, these low-yielding carbon black feedstocks generally give poor yields, low surface areas, and/or low structures in a carbon black process, compared to the traditionally used carbon black feedstocks. Performance of these feedstocks in an electrically-heated carbon black process can be so poor that it can be impossible to make the structure required for most ASTM grades with them. The maximum achievable structure at a given surface area for a feedstock helps define the grade capability of the feedstock.

Thus, there is a need in the industry to provide a solution to being able to use an electrically-heated carbon black process that can greatly increase the structure of the carbon black produced.

Also, there is a need in the industry to provide a solution to reducing capital costs, by achieving a given surface area at a lower reaction temperature for an electrically-heated carbon black process.

Further, there is a need in the industry to provide a solution to being able to use (to allow the use of) various amounts of low-yielding carbon black-forming feedstocks in an existing electrically-heated carbon black process, and yet produce carbon blacks that are comparable to carbon blacks formed from traditional carbon black feedstocks (e.g., produce carbon blacks with acceptable yields and/or with high surface areas, and/or high structures). It saves large capital and development resources to use an existing electrically-heated carbon black process to use these low-yielding feedstocks, instead of developing, designing, and building a new process to use them.

All of the patents and publications mentioned throughout are incorporated in their entirety by reference herein.

### SUMMARY OF THE PRESENT INVENTION

A feature of the present invention is to provide methods to prepare or produce carbon black from feedstocks that include low-yielding carbon black feedstock(s).

A further feature of the present invention is to provide methods to prepare or produce carbon black from feedstocks that include gaseous carbon black feedstocks.

A still further feature of the present invention is to provide methods to prepare or produce carbon black utilizing an electrically-heated carbon black process and greatly increase the structure of the carbon black produced.

Also, a feature of the present invention is to provide methods to prepare or produce carbon black utilizing an electrically-heated carbon black process and reduce capital costs, by achieving a given surface area at a lower reaction temperature for the electrically-heated carbon black process.

An additional feature of the present invention is to provide carbon blacks made from feedstocks that include low-yielding carbon black feedstocks.

Another feature of the present invention is to provide carbon blacks made from feedstocks that include gaseous carbon black feedstocks.

An additional feature is to provide methods to utilize carbon black feedstocks wherein at least a portion or more of the total amount of feedstock is a low-yielding carbon black feedstock.

A further feature is to provide a method to produce carbon blacks from low-yielding carbon black feedstocks such that the resulting carbon black has acceptable (e.g., good) yield, acceptable (e.g., high) surface area, and/or acceptable structure (e.g., high structure).

To achieve these and other advantages, and in accordance with the purposes of the present invention, as embodied and broadly described herein, the present invention, in part, relates to a method for producing a carbon black. The method includes the step of electrically heating a carrier gas or a carbon black feedstock or both to cause pyrolysis of at least a portion of the carbon black feedstock. The carbon black feedstock comprises at least one first carbon black feedstock and at least one low-yielding carbon black feedstock. In one process of the present invention, the first carbon black feedstock is first brought into contact with a heated carrier gas formed by electrically heating a carrier gas to form a reaction stream, and then combining downstream the low-yielding carbon black feedstock to the reaction stream present to form the carbon black. The method further includes recovering the carbon black in the reaction stream. In the method, the at least one low-yielding carbon black feedstock preferably includes at least 10 wt. % of the total feedstock and no more than 90 wt % of the total feedstock (based on total weight).

In addition, the present invention, in part, relates to a further method for producing a carbon black. The method includes the step of electrically heating a carrier gas or a carbon black feedstock or both to cause pyrolysis of at least a portion of the carbon black feedstock. The carbon black feedstock comprises at least one first carbon black feedstock and at least one low-yielding carbon black feedstock. In this process of the present invention, the first carbon black feedstock and the low-yielding carbon black feedstock are brought into contact with a heated carrier gas formed by electrically heating a carrier gas to form a reaction stream and form the carbon black. The at least one first carbon black feedstock and at least one low-yielding carbon black feedstock can be in the form of a blend or can be introduced separately at the same or about the same location. The method further includes recovering the carbon black in the reaction stream. In the method, the at least one low-yielding carbon black feedstock preferably includes at least 10 wt. % of the total feedstock and no more than 90 wt % of the total feedstock (based on total weight).

Further, the present invention, in part, relates to, carbon black(s) where at least 10 wt % of the feedstock used to form the carbon black is at least one low-yielding carbon black feedstock and at least 10 wt % of the feedstock used to form the carbon black is at least one carbon black feedstock.

The present invention further relates to products and/or articles, such as but not limited to, elastomer composites formed from any one or more of the carbon black of the present invention.

It is to be understood that both the foregoing general description and the following detailed description are exemplary and explanatory only and are intended to provide a further explanation of the present invention as claimed.

The accompanying drawings, which are incorporated in and constitute a part of this application, illustrate various features of the present invention and, together with the description, serve to explain the principles of the present invention.

### BRIEF DESCRIPTION OF DRAWINGS

FIG. 1 is a graph displaying the atomic H:C (hydrogen atom to carbon atom) ratio for traditional carbon black feedstocks, compared to the low-yielding feedstocks that are, in part, used in the present invention.

FIG. 2 is a graph showing the specific gravity of traditional carbon black feedstocks, compared to the low-yielding feedstocks that are used, in part, in the present invention.

FIG. 3 is a graph showing the BMCI value for traditional feedstocks, compared to the low-yielding feedstocks that are used, in part, in the present invention.

FIG. 4 is a cross sectional view of one example of a reactor suitable for preparing the carbon black of the present invention.

FIG. 5 is a cross sectional view of another example of a reactor suitable for preparing the carbon black of the present invention.

FIG. 6 is a cross sectional view of a further example of a reactor suitable for preparing the carbon black of the present invention.

### DETAILED DESCRIPTION OF THE PRESENT INVENTION

The present invention relates to methods for producing carbon blacks that utilize low-yielding carbon black feedstock, as defined and described herein, and that utilize an electrically-heated carbon black process. The present invention further relates to carbon blacks produced from one or more of these methods. With the methods of the present invention, a portion of the total carbon black feedstock utilized can be one or more low-yielding carbon black feedstocks. With the methods of the present invention, not only can small to large amounts of low-yielding carbon black feedstocks be used, there is no sacrifice with regard to the quality of carbon black produced. Thus, the methods of the present invention utilize carbon black feedstocks that are more desirable to use for environmental reasons and/or other reasons, and yet produce carbon blacks that are comparable to carbon blacks produced using traditional carbon black feedstocks used in furnace carbon black processes and/or traditional plasma processes.

A method for producing carbon black of the present invention comprises, consists essentially of, consists of, or includes combining at least one first carbon black feedstock with an electrically heated gas stream (or an electrically heated carrier gas stream) to form a reaction stream; combining downstream at least one low-yielding carbon black feedstock to the reaction stream present to form the carbon black, and recovering the carbon black in the reaction stream. In the method, preferably, the at least one low-yielding carbon black feedstock comprises at least 10 wt % of the total feedstock, and can more preferably comprise at least 25 wt. % of the total feedstock or at least 50 wt % of the total feedstock or at least 60 wt % of the total feedstock and the first carbon black feedstock comprises at least 10 wt % of the total feedstock.

Another method of the present invention comprises, consists essentially of, consists of, or includes combining a carbon black feedstock that comprises, consists essentially of, consists of, or includes at least one first carbon black feedstock and at least one low-yielding carbon black with an electrically heated gas stream (or an electrically heated carrier gas stream) to form a reaction stream to form the carbon black, and recovering the carbon black in the reaction stream. The carbon black feedstock can be introduced as a blend or multiple separate carbon black feedstocks can be introduced (e.g., at the same location or about the same location) and that are combined with the electrically heated gas stream. In the method, preferably, the at least one low-yielding carbon black feedstock comprises at least 10 wt % of the total feedstock, and can more preferably comprise at least 25 wt. % of the total feedstock or at least 50 wt % of the total feedstock, and the first carbon black feedstock comprises at least 10 wt % of the total feedstock.

For purposes of the present invention, “a low-yielding carbon black feedstock” is a carbon black feedstock having at least one of the following properties:
1) a Bureau of Mines Correlation Index (BMCI)<100 (which provides an indication of low aromatics content for liquid feeds) (e.g., a BMCI of less than 99, of less than 95, of less than 90, of less than 85, of less than 80, of less than 75, of less than 70, such as a BMCI of from 50 to 99 or from 60 to 99, or from 70 to 99, or from 50 to 95 or from 50 to 90), and/or
2) a carbon-containing material that is a gas at room temperature (e.g., 25 deg C.) and pressure (1 atm), and/or
3) an atomic H:C ratio of greater than 1.23 (e.g., an H:C ratio of 1.24 or greater, 1.25 or greater, 1.26 or greater, 1.27 or greater, 1.28 or greater, 1.29 or greater, 1.30 or greater, 1.35 or greater, 1.40 or greater, 1.45 or greater, 1.50 or greater, such as from 1.235 to 1.5, or from 1.235 to 1.45, or from 1.235 to 1.4, or from 1.235 to 1.35, or from 1.235 to 1.3 or from 1.235 to 1.29, or from 1.235 to 1.28, or from 1.235 to 1.27 or from 1.24 to 1.5, or from 1.25 to 1.5 or from 1.26 to 1.5 or from 1.27 to 1.5 or form 1.28 to 1.5 or from 1.29 to 1.5 or from 1.3 to 1.5), and/or
4) a specific gravity of at most 1.02 (e.g., at most 1.015, at most 1.01, at most 1.005, at most 1.01, at most 1.00, at most 0.99, at most 0.95, such as from 0.80 to 1.019, or from 0.80 to 1.015, or from 0.80 to 1.01, or from 0.80 to 1.005, or from 0.80 to 1.00, or from 0.80 to 0.95, or from 0.80 to 0.9, or from 0.80 to 1.015, or from 0.90 to 1.01, or from 0.90 to 1.005, or from 1.005 to 1.015).

The low-yielding carbon black feedstock can have the BMCI property only. The low-yielding carbon black feedstock can have the atomic H:C property only. The low-yielding carbon black feedstock can have the specific gravity property only. The low-yielding carbon black feedstock can have the gas property only.

The low-yielding carbon black feedstock can have the BMCI property and the atomic H:C property.

The low-yielding carbon black feedstock can have the BMCI property and the specific gravity property.

The low-yielding carbon black feedstock can have the BMCI property and the gas property.

The low-yielding carbon black feedstock can have the BMCI property, the atomic H:C property, and the specific gravity property.

The low-yielding carbon black feedstock can have the BMCI property, the atomic H:C property, and the gas property.

The low-yielding carbon black feedstock can have the BMCI property, the atomic H:C property, the specific gravity property, and the gas property.

The low-yielding carbon black feedstock can have the atomic H:C property, and the specific gravity property.

The low-yielding carbon black feedstock can have the atomic H:C property, and the gas property.

The low-yielding carbon black feedstock can have the atomic H:C property, the specific gravity property, and the gas property.

The low-yielding carbon black feedstock can have the specific gravity property and the gas property.

A low-yielding carbon black feedstock can be a feedstock derived from what is considered to be sustainable, biological, and/or recycled sources. For example, the low-yielding carbon black feedstock can be or include ethylene, a gas at room temperature and pressure. The ethylene can be produced from bio-sourced ethanol, e.g., from corn fermentation or other plant material fermentations. Another example of a low-yielding carbon black feedstock is natural gas.

The low-yielding carbon black feedstock, for purposes of the present invention, can be a feedstock that is not derived from fossil-fuel-based gasoline production or coal cracking, or cracking to produce olefins. Thus, the low-yielding carbon black feedstock is a feedstock that is other than coal tar liquid, an oil-refinery liquid, or an ethylene cracker residue.

Other examples of low-yielding liquid carbon black feedstocks can include, but are not limited to, the following: a tire pyrolysis oil, a plastic pyrolysis oil, a recycled oil, an algal oil, a plant-derived oil, an oil derived from pyrolysis of municipal solid waste, an oil derived from the pyrolysis or decay of biomass (e.g., animal or vegetable) or agricultural waste, an oil derived from the processing of pulp or paper production byproducts, and/or another oil sourced primarily from biomaterials or any combinations thereof. Exemplary low-yielding feedstocks include but are not limited to a vegetable or other plant-derived oil, a bio-sourced ethanol, a plant- or animal-produced wax or resin, an oil rendered from animal fat, an algal oil, an oil rendered from the pyrolysis of sewage sludge or agricultural waste, a byproduct liquid from processing of a biogenic material, a liquid produced by hydrothermal liquefaction of a biomaterial, a crude tall oil, a tall oil rosin, a tall oil pitch, or a tall oil fatty acid, an oil produced from recycled material, an oil derived from the pyrolysis of off-quality, rejected, or end-of-life tires, an oil derived from the pyrolysis of discarded or recycled plastics or rubber products, an oil derived from the pyrolysis of municipal solid waste, or an oil derived from the pyrolysis of biomass, or any combinations thereof. These liquid feedstocks have an atomic H:C ratio greater than 1.23, or a specific gravity of at most 1.02, or a BMCI value less than 100. Specific examples of liquid low-yielding carbon black feedstocks are presented in Table 1 below:

TABLE 1

| Label | H | I | J | K | L |
|---|---|---|---|---|---|
| Feedstock | Bolder350 | Delta-Energy | Soybean | Corn | Peanut |
| Example | Tire | Raw Tire | Oil | Oil | Oil |
| | Pyrolysis | Pyrolysis | | | |
| | Oil | Oil | | | |
| Data Source | e | f | g | h, i | h, i |
| Atomic H:C | 1.32 | 1.50 | 1.87 | 1.87 | 1.87 |
| Specific Gravity | 1.00 | 0.94 | 0.93 | 0.92 | 0.91 |
| BMCI | 94 | 62.5 | 56 | 54 | 50 |
| Sulfur Content | 1.08 | 1.03 | 0 | 0 | 0 |
| (wt % | | | | | |
| Flash Point (° C.) | 66 | 32 | >110 | 321 | 315 |

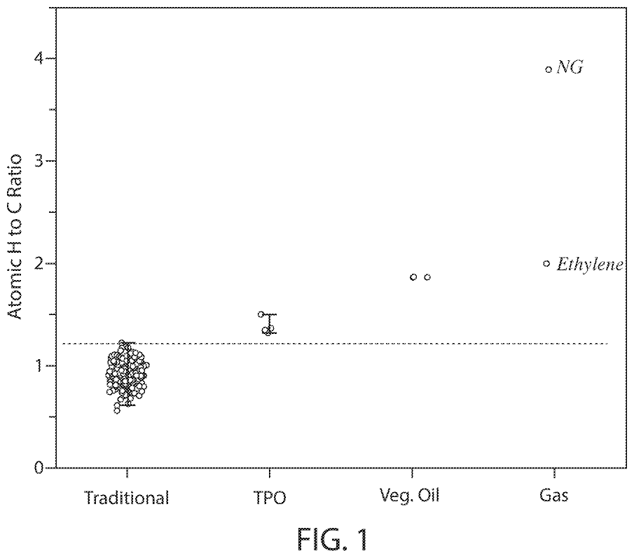

FIG. 1 is a graph that presents the atomic H:C ratio for traditional, high yielding carbon black feedstocks, compared to tire pyrolysis oils (TPO), vegetable oils (Veg. Oil), and two gas-phase feedstocks (natural gas and ethylene) (Gas). For the traditional feedstocks, the H:C is plotted for a collection of approximately 1000 representative coal tar liquids, decant oils, and ECRs used as carbon black feedstocks for the furnace black process, between 2016 and 2021. The H:C value range can be compared with the three low-yielding carbon black feedstock groups. It is clear that traditional feedstocks have a low H:C value≤1.23 (the dashed line of the figure). The low-yielding carbon black feedstocks in FIG. 1, all have an H:C value >1.23.

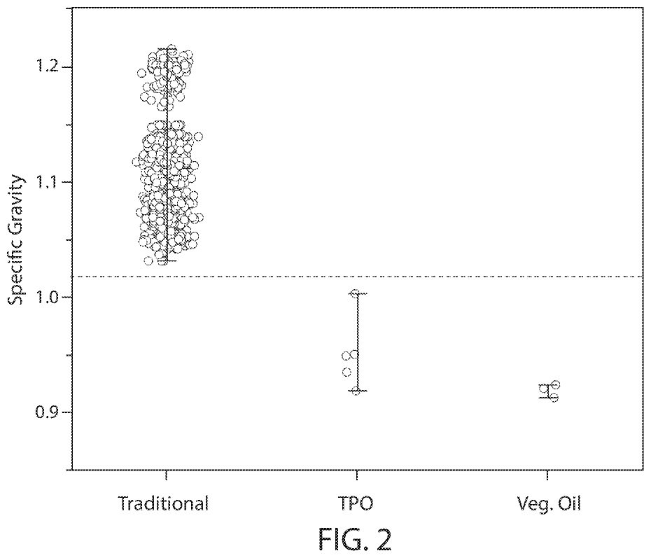

FIG. 2 is a graph that presents examples of specific gravity of traditional, high yielding feedstocks, compared to tire pyrolysis oils (TPO) and vegetable oils (Veg. Oil). For the traditional feedstocks, the specific gravity is plotted for a collection of approximately 1000 representative coal tar liquids, decant oils, and ECRs used as carbon black feedstocks for the furnace black process, between 2016 and 2021. The specific gravity range are compared with two low-yielding carbon black feedstock groups. It is clear that traditional feedstocks generally have a specific gravity greater than 1.02 (the dashed line of the figure), whereas the low-yielding carbon black feedstocks have a specific gravity that is 1.02 or less.

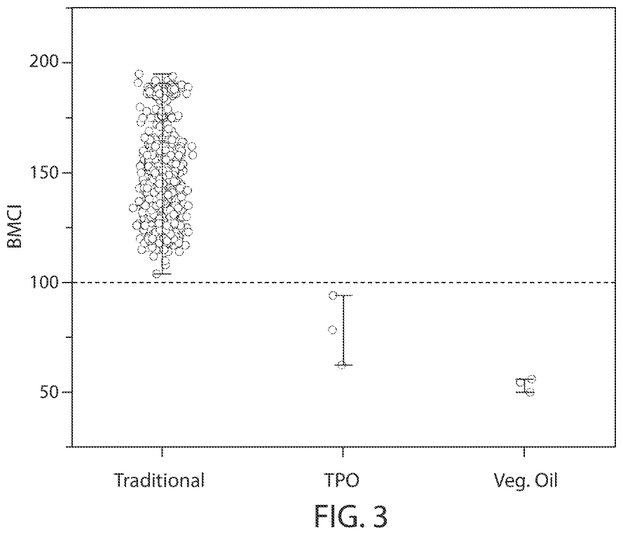

FIG. 3 is a graph that presents examples of BMCI numbers for traditional, high yielding feedstocks, compared to tire pyrolysis oils (TPO) and vegetable oils (Veg. Oil). For the traditional carbon black feedstocks, the BMCI number is plotted for a collection of approximately 1000 representative coal tar liquids, decant oils, and ECRs used as feedstocks for the furnace black process, between 2016 and 2021. Their BMCI values are compared with two low-yielding feedstock groups. Almost all traditional feedstocks have a BMCI value >110, and all examples shown here, have a BMCI number that is greater than or equal to 100 (the dashed line). By contrast, the TPO and vegetable oil groups have a BMCI number of less than 100.

Other examples of low-yielding carbon black feedstocks can include, but are not limited to, the following: a renewable feedstock, a bio-sourced or bio-based feedstock, and/or other byproduct of a refining process, or any combinations thereof.

Other examples of low-yielding carbon black feedstocks can include, but are not limited to, the following: vegetable or other plant-derived oils (e.g., corn oil and/or corn distiller's oil).

Other examples of low-yielding carbon black feedstocks can include, but are not limited to, the following: bio-sourced ethanol (from corn fermentation or other plant, vegetable, or fruit sourced fermentation products).

Other examples of low-yielding carbon black feedstocks can include, but are not limited to, the following: plant- or animal-produced waxes and resins, such as lanolin or lac.

Other examples of low-yielding carbon black feedstocks can include, but are not limited to, the following: oils rendered from animal fats.

Other examples of low-yielding carbon black feedstocks can include, but are not limited to, the following: algal oils.

Other examples of low-yielding carbon black feedstocks can include, but are not limited to, the following: oils rendered from the pyrolysis of sewage sludge or agricultural waste.

Other examples of low-yielding carbon black feedstocks can include, but are not limited to, the following: byproduct liquids from processing of biogenic materials.

Other examples of low-yielding carbon black feedstocks can include, but are not limited to, the following: liquids produced by hydrothermal liquefaction of biomaterial.

Other examples of low-yielding carbon black feedstocks can include, but are not limited to, the following: crude tall oils, tall oil rosin, tall oil pitch, or tall oil fatty acids (e.g., from paper making processes).

Other examples of low-yielding carbon black feedstocks can include, but are not limited to, the following: renewable feedstocks such as oils produced from recycled materials.

Other examples of low-yielding carbon black feedstocks can include, but are not limited to, the following: oils derived from the pyrolysis of off-quality, rejected, or end-of-life tires.

Other examples of low-yielding carbon black feedstocks can include, but are not limited to, the following: oils derived from the pyrolysis of discarded or recycled plastics.

Other examples of low-yielding carbon black feedstocks can include, but are not limited to, the following: oils derived from the pyrolysis of municipal solid waste.

Other examples of low-yielding carbon black feedstocks can include, but are not limited to, the following: oils derived from the pyrolysis of biomass (bio oil), e.g., animals or plants (e.g., vegetable).

As indicated above, in the present invention, a portion (by wt %) of the total feedstock utilized in methods of the present invention (either in a staged method or introduced as a blend or introduced at the same location or about the same location in the reactor) is one or more low-yielding carbon black feedstocks, and a portion is not a low-yielding carbon black feedstock.

For purposes of the present invention, ‘about the same location’ means that the introduction of the multiple feedstocks occurs at the same location (I₁) or within 5% of I₁ based on the entire length of the carbon black reactor.

Preferably, the amount of the low-yielding carbon black feedstock (either in a staged method or introduced as a blend or introduced at the same location or about the same location with one or more other carbon black feedstocks) is at least 10 wt %, or at least 15 wt %, or at least 20 wt %, or least 25 wt %, or at least 30 wt %, or at least 35 wt %, or at least 40 wt %, or at least 45 wt %, or at least 50 wt %, or at least 55 wt %, or at least 60 wt %, or at least 65 wt %, or at least 70 wt %, or at least 75 wt %, or at least 80 wt %, or at least 85 wt %, or at least 90 wt % but below 100 wt % and preferably below 99 wt % or below 95 wt %, such as from 10 wt % to 95 wt %, or from 10 wt % to 90 wt %, or from 15 wt % to 90 wt %, or from 20 wt % to 90 wt %, or from 25 wt % to 90 wt %, or from 30 wt % to 90 wt %, or from 35 wt % to 90 wt %, or from 40 wt % to 90 wt %, or from 45 wt % to 90 wt %, or from 50 wt % to 95 wt %, or from 10 wt % to 80 wt %, or from 10 wt % to 70 wt %, or from 10 wt % to 60 wt %, or from 10 wt % to 50 wt %, or from 10 wt % to 40 wt %, or from 10 wt % to 30 wt %, or from 60 wt % to 95 wt %, or from 65 wt % to 95 wt %, or from 70 wt % to 95 wt %, or from 75 wt % to 95 wt %, or from 60 wt % to 95 wt %, or from 60 wt % to 90 wt %, or from 60 wt % to 85 wt %, or from 60 wt % to 80 wt %, or from 60 wt % to 75 wt %, based on total weight percent of all feedstocks used.

For purposes of the present invention, a ‘first carbon black feedstock’ or a ‘high yielding carbon black feedstock’ is a feedstock that is not a low-yielding carbon black feedstock as defined herein. The first carbon black feedstock can be considered or referred to as a carbon black feedstock traditional used in furnace carbon black processes (‘traditional’ carbon black feedstocks). As discussed further herein, the first carbon black feedstock can be a blend of feedstocks that contains, as an option, low amounts of a low-yielding carbon black feedstock.

First carbon black feedstocks are typically from the family of decant or slurry oils, coal tars or coal tar distillate fractions, or ethylene or phenol cracker residues. Their defining characteristics, with respect to carbon black production in a typical furnace process are discussed further below.

A first carbon black feedstock has all three of the following properties:
1) a BMCI of at least 100 (e.g., at least 101, at least 102, at least 103, at least 104, at least 105, at least 110, at least 115, at least 120, at least 130, at least 140, at least 150, at least 160, at least 170, such as from 100 to 180, from 101 to 180, from 102 to 180, from 103 to 180, from 104 to 180, from 105 to 180, from 110 to 180, from 115 to 180, from 120 to 180, from 130 to 180, from 140 to 180, from 150 to 180, from 160 to 180, from 100 to 175, from 100 to 170, from 100 to 165, from 110 to 175, from 115 to 175, from 120 to 175, from 125 to 170, from 130 to 170),
2) a specific gravity of greater than 1.02 (e.g., greater than 1.025, greater than 1.03, greater than 1.035, greater than 1.04, greater than 1.05, such as from 1.021 to 1.3, or from 1.025 to 1.3, or from 1.03 to 1.3, or from 1.05 to 1.3, or from 1.07 to 1.25),
3) an atomic H:C ratio of at most 1.23 (e.g., at most 1.22, at most 1.21, at most 1.2, at most 1.15, at most 1.1, at most 1.05, at most 1, at most 0.9, at most 0.8, such as from 1.225 to 0.7, from 1.225 to 0.8, from 1.225 to 0.9, from 1.225 to 1, from 1.225 to 1.1, from 1.22 to 0.7, from 1.21 to 0.7 from 1.2 to 0.7).

As an option, the first carbon black feedstock may also be a liquid at room temperature and pressure (e.g., 25 deg C. and 1 atm). Despite being a liquid, the first carbon black feedstock may be a pitch or similar material with extremely high viscosity and need not exhibit noticeable flow.

Examples of first carbon black feedstocks are given in Table 2 below, and include coal tars, liquids distilled from coal tars, decant or slurry oils obtained from catalytic cracking, and residue oils from ethylene cracking. As shown in the Table 2, these feedstocks have an H:C of at most 1.23, and a specific gravity greater than 1.02, and a BMCI value of at least 100.

TABLE 2

| | Label | | | | | | |
|---|---|---|---|---|---|---|---|
| | A | B | C | D | E | F | G |
| | Feedstock Example | | | | | | |
| | Ethylene Steam | Ethylene Steam | | | | | |
| | Cracker | Cracker | | | Coal Tar | Crude Coal | |
| | Residue | Residue | Decant Oil | Decant Oil | Distillate | Tar | Decant Oil |
| | Data Source | | | | | | |
| | a | b | a | c | a | d | e |
| Atomic H:C | 0.94 | 0.91 | 0.94 | 1.01 | 0.85 | 0.72 | 1.01 |
| Specific Gravity | 1.07 | 1.08 | 1.10 | 1.11 | 1.14 | 1.22 | 1.10 |
| BMCI | 127 | 146 | 132 | 134 | 161 | 179 | 163 |
| Sulfur Content (wt %) | 0.2 | 0.17 | 2.1 | 0.95 | 0.6 | 0.38 | 1.36 |
| Flash Point (° C.) | 70 | 86 | 130 | 90 | 90 | | |

The first carbon black feedstock may also comprise a fraction derived from refining or distilling tire pyrolysis oil. Tire pyrolysis may be accomplished by any method known to those of skill in the art. Exemplary methods include but are not limited to those found in U.S. Pat. No. 8,350,105 and US20180320082, the entire contents of both of which are incorporated herein by reference. Distillation of the resulting oil may also be accomplished by any method known to those of skill in the art. Exemplary methods include but are not limited to those found in U.S. Pat. No. 9,920,262, WO2019236214, the contents of which are incorporated herein by reference. The tire pyrolysis oil may be distilled to provide at least one fraction that can be used as a first carbon black feedstock and at least one fraction that is a low yielding carbon black feedstock. Indeed, distillation may result in lightweight fractions that may be more economically employed in other unit processes of the carbon black production process, for example, as fuel for a dryer for the carbon black or for a heater to preheat either or both of the first carbon black feedstock or the second carbon black feedstock as disclosed in US20130039841, the contents of which are incorporated herein by reference. Thus, integration of the distillation process with the carbon black reactor can enable both economic and environmental benefits from the recycling of carbon black filled tires.

As an option, in methods of the present invention, the first carbon black feedstock, based on that total amount of feedstock utilized (by wt %), can be used in amount (either in a staged method or introduced as a blend or introduced at the same location or about the same location with one or more other carbon black feedstocks) of at least 10 wt %, or at least 15 wt %, or at least 20 wt %, or least 25 wt %, or at least 30 wt %, or at least 35 wt %, or at least 40 wt %, or at least 45 wt %, or at least 50 wt %, or at least 55 wt %, or at least 60 wt %, or at least 65 wt %, or at least 70 wt %, or at least 75 wt %, or at least 80 wt %, or at least 85 wt %, or at least 90 wt % but below 100 wt % and preferably below 99 wt % or below 95 wt %, such as from 10 wt % to 95 wt %, or from 10 wt % to 90 wt %, or from 15 wt % to 90 wt %, or from 20 wt % to 90 wt %, or from 25 wt % to 90 wt %, or from 30 wt % to 90 wt %, or from 35 wt % to 90 wt %, or from 40 wt % to 90 wt %, or from 45 wt % to 90 wt %, or from 50 wt % to 95 wt %, or from 10 wt % to 80 wt %, or from 10 wt % to 70 wt %, or from 10 wt % to 60 wt %, or from 10 wt % to 50 wt %, or from 10 wt % to 40 wt %, or from 10 wt % to 30 wt %, or from 60 wt % to 95 wt %, or from 65 wt % to 95 wt %, or from 70 wt % to 95 wt %, or from 75 wt % to 95 wt %, or from 60 wt % to 95 wt %, or from 60 wt % to 90 wt %, or from 60 wt % to 85 wt %, or from 60 wt % to 80 wt %, or from 60 wt % to 75 wt %, based on total weight percent of all feedstocks used. Other amounts of the first carbon black feedstock based on that total amount of feedstock utilized (by wt %), can be 49 wt % or less, 45 wt % or less, 40 wt % or less, 35 wt % or less, 30 wt % or less, 25 wt % or less, 20 wt % or less, 15 wt % or less, 10 wt % or less, 9 wt % or less, 8 wt % or less, 7 wt % or less, 6 wt % or less, such as from 5 wt % to 49 wt % or from 5 wt % to 45 wt %, or from 10 wt % to 40 wt %, or from 10 wt % to 35 wt %, or from 10 wt % to 30 wt %).

The first carbon black feedstock can be a liquid under room temperature (e.g., 25 deg C.) and atmosphere (e.g., 1 atm) conditions. “Rich in aromatic species” means that the feedstock has a high amount of aromatic compounds present. For instance, a high amount of aromatic compounds is where the total weight percent of aromatics present is at least 20 wt % or has a BMCI of at least 100 or both. The first carbon black feedstock can be heated so that the feedstock is in vapor form and thus can become, or be used in practice as, a vapor rich in aromatic species.

With respect to the method steps of the present invention, some methods of the present invention include combining an electrically heated gas stream (or an electrically heated carrier gas stream) with the first carbon black feedstock and low-yielding carbon black feedstock. As explained further and previously, the first carbon black feedstock and the low-yielding carbon black feedstock can be introduced or combined with the heated gas stream in a staged manner (e.g., the first carbon black feedstock is introduced first and then downstream the low-yielding carbon black feedstock is introduced or a blend of the first carbon black feedstock and the low-yielding carbon black feedstock are introduced or combined with the heated gas stream), or the first carbon black feedstock and the low-yielding carbon black feedstock are introduced or combined with the heated gas stream at or about the same location in the carbon black reactor).

In other methods of the present invention, the carbon black feedstock or portion thereof is electrically heated such that pyrolysis of the feedstock occurs.

In the methods of the present invention, the electrically heating of either a carrier gas and/or carbon black feedstock can be such that the electrically heating is direct or indirect (e.g., meaning for direct, the heating element contacts the carrier gas and/or feedstock).

To create the electrically heated gas stream, there are at least four methods that can be utilized for purposes of the present invention. In any of the methods, electrical energy is utilized to heat either a carrier gas and/or a carbon black feedstock such that pyrolysis of at least a portion of the carbon black feedstock occurs.

The present invention can be practiced in several variations or embodiments.

In a first method, an arc can be used to electrically heat a carrier gas which is then contacted with the carbon black feedstock(s) as described herein. As the arc creates a plasma, this method at times is referred to as a plasma process.

In a second method, a heating element, either resistive or inductive-based, is used to electrically heat the carrier gas, which is then contacted with the carbon black feedstock(s) as described herein.

In a third method, an inductive or microwave-based plasma is used to heat either a carrier gas, or the carbon black feedstocks themselves, without direct contact between the gas and the electrodes.

In a fourth method, a plasma arc or heating element is in direct contact with the carbon black feedstock(s) and this is used to heat the feedstock. U.S. Pat. Nos. 8,221,689 and 7,563,525 further described these methods which can be utilized in the present invention.

The methods utilized to form or create the electrically heated gas stream and/or carbon black feedstock and the apparatus/device(s) and conditions/parameters for doing so are commercially available and can be adopted or utilized here for the methods of the present invention.

In more detail, and simply as examples, an example of the first method (a plasma process with carrier gas), and the second method (an electrically heated process with carrier gas), are described in further detail.

The plasma process can be used to produce carbon black by heating a suitable carrier gas stream to high temperatures such that pyrolysis of the carbon black feedstock(s) can occur when combined with the electrically heated carrier gas stream (e.g., 3000 deg C. or higher). The heating can be achieved with an electric arc. Once the heated carrier gas stream is formed, a carbon black feedstock(s) can be introduced to this heated carrier gas stream or combined with this heated carrier gas stream. The hot carrier gas stream contains a substantial portion of the energy required to drive rapid, high-temperature pyrolysis of the feedstock to carbon black and byproduct gases. Further details of this process, which can be adopted in the methods of the present invention, are set forth in U.S. Pat. No. 9,574,086 (incorporated in its entirety by reference herein).

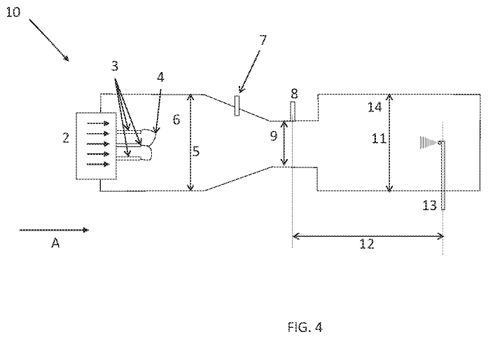

An example of a set-up and reactor for the plasma process 10 is shown in FIG. 4, which shows a cross-sectional view of a carbon black reactor 10. A carrier gas, such as hydrogen or argon, is introduced, e.g., via a duct 2, into a plasma-generation chamber 6 of diameter 5. The bulk flow of materials is in direction A. Electrodes 3 generate an electric arc 4 which heats the carrier gas, typically to plasma conditions.

The heated carrier gas is then combined or mixed with a carbon black feedstock, that for instance, can be introduced by injectors 7 and 8. Injector 7 may be positioned at a location that has a narrower diameter than diameter 5. In FIG. 4, injector 8 is depicted downstream of injector 7 at a throat 9 having the narrowest diameter of carbon black reactor 10. Alternatively injector 8 can be positioned downstream of injector 7 but in a region having a wider diameter than throat 9. Injector 7, for instance, can introduce or inject a first carbon black feedstock into the reactor and a further carbon black feedstock, e.g., a low-yielding carbon black feedstock, can be introduced at injection point 8. The distance between injectors 7 and 8 only needs to be long enough for the first carbon black feedstock injected into reactor 10 at injector 7 to become mixed into the carrier gas. In the present invention, generally, at least a portion if not all of the first carbon black feedstock can be injected or introduced at least prior to introducing the low-yielding carbon black feedstock into the reactor. Preferably, a majority of the first carbon black feedstock is introduced prior to introducing any low-yielding carbon black feedstock. To aid this mixing process, the hot carrier gas can be forced into the narrower throat 9 to increase turbulence and generate fast mixing. As the first carbon black feedstock is typically injected as a liquid, the increased turbulence produced by the contraction may also aid atomization of the liquid droplets.

After the injection of the first and low-yielding carbon black feedstocks, the combined stream of hot carrier gas and reacting feedstock enters a suitable reaction chamber 14 of diameter 11. Diameter 11, as well as diameter 5, can be substantially larger than that of the throat 9. At some location 12 downstream of the final feedstock injection point, the mixture is quenched using a gas or liquid spray 13.

The throat 9 in FIG. 4 can be optional and not used. As an option, a single injection point can be used (e.g., either injection point 7 or injection point 8) where the first and low-yielding carbon black feedstocks are introduced as a blend. As another option, more than the two injection points for feedstock shown 7 and 8 can be used.

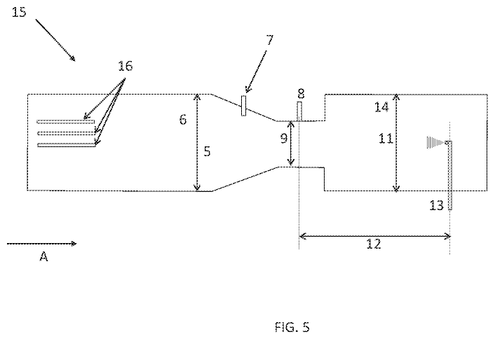

It is possible to replace entirely, or partially replace, the plasma heating apparatus in FIG. 4, with a system 15 made of electrically resistive heating wire, or inductively-heated elements, as shown in FIG. 5, which depicts a cross-section of another reactor 15. The process and apparatus is similar to that in FIG. 4, except that the carrier gas is now heated differently from a plasma-producing arc. FIG. 5 depicts a set of resistive heating elements 16 (e.g., rods) positioned in the path of a carrier gas that is introduced through a duct (not shown) in a manner similar to the apparatus of FIG. 4. In FIG. 5, resistive heating elements 16 heat the carrier gas flowing in direction A. After the step of heating the carrier gas, the process may be the same as described in connection with FIG. 4. Alternatively or in addition, ceramic heating elements such as magnesium oxide or yttria-stabilized zirconia may be employed.

Elements 16 may be heated by subjecting them to a passing electric current, or may be inductively heated, for example by subjecting them to microwave, radio frequency, or other appropriate electromagnetic radiation. As known in the art, the electromagnetic energy in the microwave radiation causes electrons to move in the rods, heating them. This method allows a reactor without direct penetration for electrical connections, which can be beneficial in certain instances. For example, SiC rods will become hot when subjected to microwave radiation. In this embodiment, there is no need to have electrical wires or other conductors crossing into the heating chamber, thus reducing design complexity.

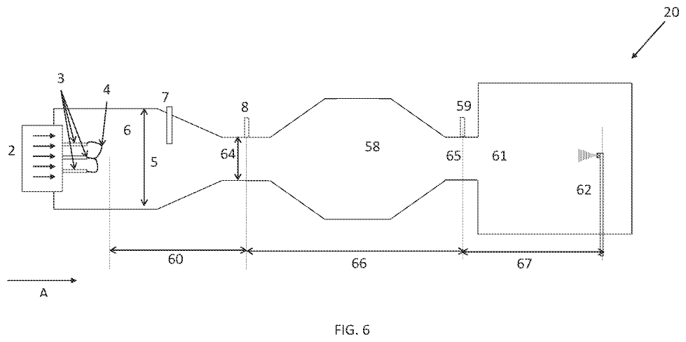

The methods of the present invention can be applied to an electrically-heated process and reactor as shown in FIG. 6. FIG. 6 illustrates a cross section of another example of a carbon black reactor 20 having similar features as apparatus 10 of FIG. 4. In contrast to FIG. 4, reactor 20 features two contracting throats 64 and 65 of narrowing diameter on either end of a middle chamber 58. Hot carrier gas from duct 2 fed toward contracting throat 64. The first carbon black feedstock is fed through injectors 7, or 8, or both simultaneously, and mixed with the carrier gas.

In FIG. 6, the length between introduction of the carrier gas and the middle of the contraction 64, is labeled as length 60. This length can be preferably from 1× (times) to 10X the narrowest diameter of the first contraction 64. Adjusting this length may allow balancing of carbon black structure and process economics. Height or diameter 5 is shown for the heated gas chamber and this height is greater than the height or diameter 64. The height or diameter 64 can be at least 20%, at least 30%, at least 40%, at least 50% smaller than height or diameter 5.

Following the introduction of the first carbon black feedstock, the hot gas stream mixed with the feedstock enters a first reaction chamber 58. The purpose of the chamber is to provide residence time so that pyrolysis reactions that produce carbon black may complete an induction time and begin, and optionally, to produce a seed particle population for later structure growth. The length of this chamber 66 can be typically from 1× to 20× the narrowest diameter of the first contraction 64.

At the end of the first reaction chamber 58, the low-yielding carbon black feedstock can be introduced. It may be introduced using an injector or injector array 59 positioned within or near a second contraction 65 and/or substantially downstream from the first locations 7 and/or 8. Alternatively, the low-yielding carbon black feedstock may be introduced with a lance substantially upstream of contraction 65, but within chamber 58.

Distance 66, between contracting throats 64 and 65, can be greater than the diameter 64 and can be adjusted to alter or optimize product properties. Contracting throats 64 and 65 can have the same or different diameters. One of skill in the art will recognize how to adjust these diameters to obtain desired mixing characteristics for the reaction stream.

After introduction of the low-yielding carbon black feedstock, the mixture flows into a second reaction chamber 61. It is then quenched using a cooling spray of liquid or vapor 62, as is known in the art. The length from the low-yielding carbon black feedstock's injection point 59 to quench location 62 is labeled as 67 in FIG. 6. This length is set to provide a residence time that controls certain product properties as is known in the art.

An alternative arrangement introduces the first carbon black feedstock at location 7 and/or location 8, and then introduces the low-yielding carbon black feedstock at locations 8 and/or 59 (and/or a location between these locations), which can be simultaneously if both locations are used. This can offer a beneficial tradeoff between structure capability and yield or process economics. In all the above embodiments, at least a portion, preferably the majority of the first carbon black feedstock that is used, for example, all of the first carbon black feedstock, is introduced before and upstream of the low-yielding carbon black feedstock.

With the present invention, the methods permit a gas-phase carbon black feedstock or other non-traditional, low-yielding carbon black feedstock, to produce carbon black structures greater than what is achievable in conventional methods that may use non-traditional carbon black feedstocks.

Moreover, with the present invention, it is possible to lower the temperature required to produce a given surface area, compared to exclusive use of the non-traditional feedstocks. This means less carrier gas is required, lowering capital costs in the electrically-heated process. For instance, the temperature may be lowered by 2% to 5% or more.

Injector 7, for instance, can introduce or inject a first carbon black feedstock into the reactor. As an alternative, the first carbon black feedstock may also be introduced into the chamber using an axial pipe or lance. As a further alternative, the first carbon black feedstock may be injected or introduced by multiple methods simultaneously. The lance or any other injector exposed to the reactor may need to be cooled or protected from excessive heat in the reactor, by methods known in the art.

In the present invention, as an option, at least a portion if not all of the first carbon black feedstock can be injected or introduced prior to introducing the low-yielding carbon black feedstock into the reactor. Preferably, the amount of the first carbon black feedstock injected or introduced into the reactor prior to introducing the low-yielding carbon black feedstock is greater than the total amount of first carbon black feedstock introduced in any later stages. That is, the majority (>50%) of the first carbon black feedstock used in the reactor is introduced or injected in the first stage (e.g., at location/injector 7 in FIG. 4).

The carbon black feedstocks can be injected into the heated carrier gas stream through one or more nozzles designed for optimal distribution of the feedstock into the gas stream. Such nozzles may be either single or bi-fluid. Bi-fluid nozzles may use, for example, steam, air, or nitrogen to atomize the feedstock. Single-fluid nozzles may be pressure atomized or the feedstock can be directly injected into the gas-stream. In the latter instance, atomization occurs by the force of the gas-stream.

The carbon black feedstock may be injected by an axial injection lance or a central pipe can be used and/or one or more radial lances arranged on the circumference of the reactor in a plane perpendicular to the flow direction. A reactor may contain several planes with radial lances along the flow direction. Spray or injection nozzles can be arranged on the head of the lances by means of which the feedstock is mixed into the flow of the heated gas stream.

The first carbon black feedstock can be introduced at one or more locations, or simultaneously in two locations at the same time, or in three or more locations simultaneously. The manner and division of the first feedstock injection, when more than one location is used, among these locations can be varied to modify product properties and process economics. Injectors as well as the reactor chamber(s) (or portions thereof), may be cooled as needed by methods known in the art.

In yet another example of the present invention, the first carbon black feedstock may be a blend of a high yielding carbon black feedstock satisfying the BMCI, specific gravity, and H:C parameters described above and a low-yielding carbon black feedstock, provided the blend satisfies the BMCI, specific gravity, and H:C parameters described above for the first carbon black feedstock. The blend may contain more than 50 wt % of the high yielding carbon black feedstock by mass (e.g., 50.5 wt % to 99.5 wt % of the high yielding carbon black feedstock, such as from 60 wt % to 99 wt %).

Similarly, the low-yielding carbon black feedstock can optionally be a blend of a high yielding carbon black feedstock and a non-high yielding carbon black feedstock that fails to satisfy at least one of the BMCI, H:C, and specific gravity parameters required for the first carbon black feedstock, provided that the blend also fails to satisfy at least one of the BMCI, H:C, and specific gravity parameters required for the first carbon black feedstock. The non-high yielding carbon black feedstock may be present in an amount of more than 50% of the total feedstock of this optional blend, by mass (e.g., 50.5 wt % to 99.5 wt % of the non-high yielding carbon black feedstock such as from 60 wt % to 99 wt %).

Additionally, as an option, the total amount of first carbon black feedstock introduced to the reactor through the sum of all injection locations can be less than 50 wt % based on the total amount of carbon black feedstock used anywhere in the reactor. The total amount of low-yielding carbon black feedstock can be greater than 50 wt % based on total feedstock.

As an option, in one method of the present invention, the method includes the step of introducing at least one first carbon black feedstock with the heated gas stream, in the carbon black reactor, to form a reaction stream. The first carbon black feedstock can be one or a combination of two or more different first carbon black feedstocks. When more than one type of feedstock is utilized as the first carbon black feedstock, the multiple first carbon black feedstocks can be blended together and injected as one blended feedstock through one or multiple locations, or each feedstock can be separately injected into the reactor at the same or different locations.

As an option, in one method of the present invention, the method includes the step of introducing at least one low-yielding carbon black feedstock into a reaction stream. The low-yielding carbon black feedstock can be one or a combination of two or more different low-yielding carbon black feedstocks. When more than one type of feedstock is utilized as the low-yielding carbon black feedstock, the multiple low-yielding carbon black feedstocks can be blended together and injected as one blended feedstock through one or multiple locations, or each feedstock can be separately injected into the reactor at the same or different locations.

Generally, any of the carbon black feedstocks that are utilized in any of the methods of the present invention can be injected into a reactor by a single stream or a plurality of streams using injectors, which penetrate into the interior regions of the heated gas stream. An injector can better ensure a high rate of mixing and shearing of the heated gas stream and the carbon black feedstock(s). This ensures that the feedstock pyrolyzes and preferably at a rapid rate and/or high yield to form the carbon black of the present invention.

The first carbon black feedstock can be introduced at one location in the reactor or at multiple locations in the reactor. In one embodiment of the present invention, the low-yielding carbon black feedstock can be introduced at one location in the reactor or at multiple locations in the reactor. As indicated, in this method of the present invention, the location or locations in the reactor can be downstream of the location/locations of where the first carbon black feedstock is injected or introduced. The introducing of the low-yielding carbon black feedstock can be done with one or more injectors (e.g., a metal pipe(s) located on the wall of the reactor) which introduce the feedstock in the reactor. The injector can have an injector head or spray head on the tip. The injector on the tip can have, for instance, one or multiple holes (2 or 3 or 4 or more) around the tip (generally evenly spaced multiple holes).

As an option, the introduction of the low-yielding carbon black feedstock into the reactor and into the reaction stream can be such that the feedstock is introduced perpendicular to the lateral flow of the reaction stream through the reactor, as for instance shown in FIGS. 4-6. Perpendicular can be plus or minus 15 degrees from a true perpendicular injection of the feedstock into the reaction stream.

As an option, the introduction of the low-yielding carbon black feedstock into the reactor can be at a location that has a narrower diameter than the diameter of the reactor where the first carbon black feedstock was earlier introduced. For example, injector 8 in FIG. 4 is in a narrower portion of reactor 10 than injector 7. This location can be considered a ‘throat’ in some carbon black reactors. This narrower diameter can have a diameter that is at least 10% smaller, at least 20% smaller, or at least 30% smaller, or from 10% to 40% smaller than the diameter of the reactor where the first carbon black feedstock was earlier introduced.

As an option, the introduction of the low-yielding carbon black feedstock into the reactor and into the reaction stream can be at a location that is a distance from where the first carbon black feedstock is introduced or injected in the reactor, and this distance can be at least 1 or at least 2 times the narrowest diameter, e.g., diameter 9 or 64, of the initial chamber 6 of the reactor (or is at least 2 times the diameter of the reactor where the first carbon black feedstock was introduced or injected). This distance can be at least 2.25, at least 2.5, at least 2.75, at least 3, at least 3.25, at least 3.5, at least 3.75, or at least 4 times the diameter of the initial chamber (e.g., where the carrier gas and/or feedstock is electrically heated) of the reactor (or is at least 2.25, at least 2.5, at least 2.75, at least 3, at least 3.25, at least 3.5, at least 3.75, or at least 4 times the diameter of the reactor where the first carbon black was introduced or injected).

The low-yielding carbon black feedstock can be introduced at location 8 and/or 59 through one or more injectors.

After the feedstocks (first carbon black feedstock and low-yielding carbon black feedstock) are combined with the heated gas stream, the methods of the present invention generally include the step of quenching the reaction.

The reaction is arrested in the quench zone of the reactor (see 62 of FIG. 6). As shown in FIG. 6, quench 62 is located downstream of the last feedstock injection zone and sprays a quenching fluid, such as water, into the stream of newly formed carbon black particles. In general, the quench serves to cool the carbon black particles and to reduce the temperature of the gaseous stream and decrease the reaction rate. Distance 67 is the distance from the beginning of last feedstock injection point to quench point 62, and will vary according to the position of the quench. Optionally, quenching may be staged, or take place at several points in the reactor. A pressure spray, a gas-atomized spray or other quenching techniques also can be utilized. With respect to completely quenching the reactions to form the carbon black, any means known to those skilled in the art to quench the reaction downstream of the introduction of the carbon black yielding feedstocks can be used. For instance, a quenching fluid, which may be water or other suitable fluids, can be injected to stop the chemical reaction.

After quenching, the cooled gases and carbon black pass downstream into any conventional cooling and separating means whereby the product is recovered. The separation of the carbon black from the gas stream is readily accomplished by conventional means such as a precipitator, cyclone separator, bag filter or other means known to those skilled in the art. After the carbon black is separated from the gas stream, the carbon black can be optionally subjected to a pelletization step.

For any of the methods of the present invention, as an option, the carbon black produced is not a carbon black with a core and a coating.

For any of the methods of the present invention, as an option, the carbon black is entirely formed in-situ in the reactor.

As an option, any one or more of the carbon black feedstocks or other components used in the methods of the present invention can be pre-heated prior to introduction into the reactor. Suitable pre-heating temperatures and/or pre-heating techniques can be used in the present invention as set forth in, for example, in U.S. Pat. No. 3,095,273 issued on Jun. 25, 1963 to Austin; U.S. Pat. No. 3,288,696 issued on Nov. 29, 1966 to Orbach; U.S. Pat. No. 3,984,528 issued on Oct. 5, 1976 to Cheng et al.; U.S. Pat. No. 4,315,901, issued on Feb. 16, 1982 to Cheng et al.; U.S. Pat. No. 4,765,964 issued on Aug. 23, 1988 to Gravley et al.; U.S. Pat. No. 5,997,837 issued on Dec. 7, 1999 to Lynum et al. U.S. Pat. No. 7,097,822 issued on Aug. 29, 2006 to Godal et al.; U.S. Pat. No. 8,871,173B2, issued on Oct. 28, 2014 to Nester et al. or CA 682982, all documents being incorporated herein by reference in their entirety. Alternatively or in addition, the low yielding carbon black feedstock may be pre-heated to a higher temperature than is typical for a higher yielding feedstock. For example, the low yielding carbon black feedstock may be heated to a temperature in excess of 600 deg C., for example, 600-800 deg C., even at ambient pressure. Because the low yielding carbon black feedstock has a low concentration of asphaltenes, heating to such a high temperature does not generate significant amounts of coke or other solid non-carbon black species. Alternatively or in addition, any one or more of the carbon black feedstocks may be combined with an extender fluid prior to introduction into the reactor, for example, as described in U.S. Pat. No. 10,829,642 to Unrau, the entire contents of which are incorporated herein by reference.

As an option, the method is conducted in the absence of at least one substance that is or that contains at least one Group IA or Group IIA element (or ion thereof) of the Periodic Table.

As an option, in any of the methods of the present invention, the method can include the step of introducing at least one substance that is or that contains at least one Group IA or Group IIA element (or ion thereof) of the Periodic Table. Preferably, the substance contains at least one alkali metal or alkaline earth metal. Examples include lithium, sodium, potassium, rubidium, cesium, francium, calcium, barium, strontium, or radium, or combinations thereof. Any mixtures of one or more of these components can be present in the substance. The substance can be a solid, solution, dispersion, gas, or any combinations thereof. More than one substance having the same or different Group IA or Group IIA metal can be used. If multiple substances are used, the substances can be added together, separately, sequentially, or in different reaction locations. For purposes of the present invention, the substance can be the metal (or metal ion) itself, a compound containing one or more of these elements, including a salt containing one or more of these elements, and the like. Preferably, the substance is capable of introducing a metal or metal ion into the reaction that is ongoing to form the carbon black product. For purposes of the present invention, preferably, the substance is introduced prior to the complete quenching as described above. For instance, the substance can be added at any point prior to the complete quenching, including prior to the introduction of one or both of the carbon black yielding feedstocks; during the introduction of any one or both of the carbon black yielding feedstocks; after the introduction of any or all of the carbon black yielding feedstocks; or after the introduction of the all of the feedstocks but prior to the complete quenching. More than one point of introduction of the substance can be used. The amount of the Group IA or Group IIA metal containing substance can be any amount as long as a carbon black product can be formed. For instance, the amount of the substance can be added in an amount such that 200 ppm or more of the Group IA or Group IIA element is present in the carbon black product ultimately formed. Other amounts include from about 200 ppm to about 5000 ppm or more and other ranges can be from about 300 ppm to about 1000 ppm, or from about 500 ppm to about 1000 ppm of the Group IA or Group IIA element present in the carbon black product that is formed. These levels can be with respect to the metal ion concentration. As stated, these amounts of the Group IA or Group IIA element present in the carbon black product that is formed can be with respect to one element or more than one Group IA or Group IIA element and would be therefore a combined amount of the Group IA or Group IIA elements present in the carbon black product that is formed. The substance can be added in any fashion including any conventional means. In other words, the substance can be added in the same manner that a carbon black yielding feedstock is introduced. The substance can be added as a gas, liquid, or solid, or any combination thereof. The substance can be added at one point or several points and can be added as a single stream or a plurality of streams. The substance can be mixed in with the feedstock, fuel, and/or oxidant prior to or during their introduction.

With respect to the carbon black formed by any of the methods of the present invention, the carbon black formed or produced can be any reinforcing or non-reinforcing grade of carbon black. Examples of reinforcing grades are N110, N121, N220, N231, N234, N299, N326, N330, N339, N347, N351, N358, and N375. Examples of semi-reinforcing grades are N539, N550, N650, N660, N683, N762, N765, N774, N787, and/or N990.

The carbon black can be characterized by specific surface area, structure, aggregate size, shape, and distribution; and/or chemical and physical properties of the surface. The properties of carbon black are analytically determined by tests known to the art. For example, nitrogen adsorption surface area and Statistical Thickness Surface Area (STSA), another measure of surface area, are determined by nitrogen adsorption following ASTM test procedure D6556. The Iodine number can be measured using ASTM procedure D1510. Carbon black “structure” describes the size and complexity of aggregates of carbon black formed by the fusion of primary carbon black particles to one another. As used here, the carbon black structure can be measured as the oil absorption number (OAN) for the uncrushed carbon black, expressed as milliliters of oil per 100 grams carbon black, according to the procedure set forth in ASTM D2414. The Compressed Sample Oil absorption number (COAN) measures that portion of the carbon black structure which is not easily altered by application of mechanical stress. COAN is measured according to ATSM D3493. Aggregate size distribution (ASD) is measured according to ISO 15825 method using Disc Centrifuge Photosedimentometry with a model BI-DCP manufactured by Brookhaven Instruments.

Carbon black materials having suitable properties for a specific application may be selected and defined by the ASTM standards (see, e.g., ASTM D1765 Standard Classification System for Carbon Blacks Used in Rubber Products), e.g., N100, N200, N300, N500, N600, N700, N800, or N900 series carbon blacks, for example, N110, N121, N220, N231, N234, N299, N326, N330, N339, N347, N351, N358, N375, N539, N550, N650, N660, N683, N762, N765, N774, N787, or N990 carbon blacks, or other commercial grade specifications.

The carbon black can have any STSA such as ranging from 5 m²/g to 250 m²/g, 11 m²/g to 250 m²/g, 20 m²/g to 250 m²/g or higher, for instance, at least 70 m²/g, such as from 70 m²/g to 250 m²/g, or 80 m²/g to 200 m²/g or from 90 m²/g to 200 m²/g, or from 100 m²/g to 180 m²/g, from 110 m²/g to 150 m²/g, from 120 m²/g to 150 m²/g and the like. As an option, the carbon black can have an Iodine Number (I2 No) of from about 5 to about 35 mg I₂/g carbon black (per ASTM D1510).

The carbon black particles disclosed herein can have a BET surface area, measured by Brunauer/Emmett/Teller (BET) technique according to the procedure of ASTM D6556, from 5 m²/g to 300 m²/g, for instance between 50 m²/g and 300 m²/g, e.g., between 100 m²/g and 300 m²/g. The BET surface area can be from about 100 m²/g to about 200 m²/g or from about 200 m²/g to about 300 m²/g.

The oil adsorption number (OAN) can be from 40 mL/100 g to 200 mL/100 g, for instance between 60 mL/100 g and 200 mL/100 g, such as between 80 mL/100 g and 200 mL/100 g, e.g., between 100 mL/100 g and 200 mL/100 g or between 120 mL/100 g and 200 mL/100 g, mL/100 g 140 mL/100 g and 200 mL/100 g mL/100 g, 160 and 200 mL/100 g or such as between 40 mL/100 g and 150 mL/100 g or 40 mL/100 g and 150 mL/100 g.

The COAN can be within the range of from about 40 mL/100 g to about 150 mL/100 g, e.g., between about 55 mL/100 g to about 150 mL/100 g, such as between about 80 mL/100 g to about 150 mL/100 g, or between about 80 mL/100 g to about 120 mL/100 g.

The carbon black can be a carbon product containing silicon-containing species and/or metal containing species and the like, which can be achieved by including the further step of introducing such a species with or in addition to either or both of the carbon black-yielding feedstocks. The carbon black can be for purposes of the present invention, a multi-phase aggregate comprising at least one carbon phase and at least one metal-containing species phase or silicon-containing species phase (also known as silicon-treated carbon black, such as ECOBLAK™ materials from Cabot Corporation).

As stated, the carbon black can be a rubber black, and especially a reinforcing grade of carbon black or a semi-reinforcing grade of carbon black.

As an option, the carbon black of the present invention can have functional groups or chemical groups (e.g., derived from small molecules or polymers, either ionic or nonionic) that are directly attached to the carbon surface (e.g., covalently attached). Examples of functional groups that can be directly attached (e.g., covalently) to the surface of the carbon black particles and methods for carrying out the surface modification are described, for example, in U.S. Pat. No. 5,554,739 issued to Belmont on Sep. 10, 1996 and U.S. Pat. No. 5,922,118 to Johnson et al. on Jul. 13, 1999, incorporated herein by reference in their entirety. As one illustration, a surface modified carbon black that can be employed here is obtained by treating carbon black with diazonium salts formed by the reaction of either sulfanilic acid or para-amino-benzoic acid (PABA) with HCl and NaNO₂. Surface modification by sulfanilic or para-amino-benzoic acid processes using diazonium salts, for example, results in carbon black having effective amounts of hydrophilic moieties on the carbon coating.

The carbon black can be surface modified according to U.S. Pat. No. 8,975,316 to Belmont et al., the contents of which are incorporated herein by reference in their entirety.

Other techniques that can be used to provide functional groups attached to the surface of the carbon black are described in U.S. Pat. No. 7,300,964, issued to Niedermeier et al, on Nov. 27, 2007.

Oxidized (modified) carbon black can be prepared in a manner similar to that used on carbon black, as described, for example, in U.S. Pat. No. 7,922,805 issued to Kowalski et al. on Apr. 12, 2011, and in U.S. Pat. No. 6,471,763 issued to Karl on Oct. 29, 2002, and incorporated herein by reference in their entirety. An oxidized carbon black is one that that has been oxidized using an oxidizing agent in order to introduce ionic and/or ionizable groups onto the surface. Such particles may have a higher degree of oxygen-containing groups on the surface. Oxidizing agents include, but are not limited to, oxygen gas, ozone, peroxides such as hydrogen peroxide, persulfates, including sodium and potassium persulfate, hypohalites such a sodium hypochlorite, oxidizing acids such a nitric acid, and transition metal containing oxidants, such as permanganate salts, osmium tetroxide, chromium oxides, or ceric ammonium nitrate. Mixtures of oxidants may also be used, particularly mixtures of gaseous oxidants such as oxygen and ozone. Other surface modification methods, such as chlorination and sulfonylation, may also be employed to introduce ionic or ionizable groups. The carbon black may be surface modified by any method known to those of skill in the art. For example, the carbon black may be heat treated as described in U.S. Pat. No. 10,767,028, the entire contents of which are incorporated herein by reference.

The carbon black can be utilized in various applications, such as, for example, as reinforcement in rubber products, e.g., tire components.

The carbon black can be incorporated in rubber articles, being used, for instance, for tire tread, especially in tread for passenger car, light vehicle, truck and bus tires, off-the-road (“OTR”) tires, airplane tires and the like; sub-tread; wire skim; sidewalls; cushion gum for retread tires; and other tire uses.

In other applications, the particles can be used in industrial rubber articles, such as engine mounts, hydro-mounts, bridge bearings and seismic isolators, tank tracks or tread, mining belts, hoses, gaskets, seals, blades, weather stripping articles, bumpers, anti-vibration parts, and others.

The carbon black can be added as an alternative or in addition to first reinforcing agents for tire components and/or other industrial rubber end-uses. The carbon black can be combined with natural and/or synthetic rubber in a suitable dry or wet mixing process based on an internal batch mixer, continuous mixer or roll mill.

Alternatively, the carbon black may be mixed into rubber via a liquid masterbatch process. For instance, a slurry containing the particles described herein also can be combined with elastomer latex in a vat and then coagulated by the addition of a coagulant, such as an acid, using the techniques described in U.S. Pat. No. 6,841,606.

The carbon black can be introduced according to U.S. Pat. No. 6,048,923, issued to Mabry et al. on Apr. 11, 2000, incorporated herein by reference in its entirety. For example, a method for preparing elastomer masterbatch can involve feeding simultaneously a particulate filler fluid and an elastomer latex fluid to a mixing zone of a coagulum reactor. A coagulum zone extends from the mixing zone, preferably progressively increasing in cross-sectional area in the downstream direction from an entry end to a discharge end. The elastomer latex may be either natural or synthetic and the particulate filler comprises, consists essentially of or consists of the material such as described above. The particulate filler is fed to the mixing zone preferably as a continuous, high velocity jet of injected fluid, while the latex fluid is fed at low velocity. The velocity, flow rate and particulate concentration of the particulate filler fluid are sufficient to cause mixture with high shear of the latex fluid and flow turbulence of the mixture within at least an upstream portion of the coagulum zone so as to substantially completely coagulate the elastomer latex with the particulate filler prior to the discharge end. Substantially complete coagulation can occur without the need of acid or salt coagulation agent. As disclosed in U.S. Pat. No. 6,075,084, incorporated herein by reference in its entirety, additional elastomer may be added to the material that emerges from the discharge end of the coagulum reactor. As disclosed in U.S. Pat. No. 6,929,783, incorporated herein by reference in its entirety, the coagulum may then be fed to a dewatering extruder. Other examples of suitable masterbatch processes are disclosed in U.S. Pat. No. 6,929,783 to Chung et al.; US 2012/0264875A1 application of Berriot et al.; U.S. 2003/0088006A1 application of Yanagisawa et al.; and EP 1 834 985 B1 issued to Yamada et al.

Carbon black may be evaluated in a suitable rubber formulation, utilizing natural or synthetic rubber. Suitable amounts of carbon black to be used can be determined by routine experimentation, calculations, by taking into consideration factors such as typical loadings of standard ASTM blacks in comparable manufacturing processes, parameters specific to the techniques and/or equipment employed, presence or absence of other additives, desired properties of the end product, and so forth.

The performance of the carbon black as a reinforcing agent for rubber compounds can be assessed by determining, for example, the performance of a rubber composition utilizing the particles relative to the performance of a comparative rubber composition that is similar in all respects except for the use of a carbon black grade suitable for the given application. In other approaches, values obtained for compositions prepared according to the invention can be compared with values known in the art as associated with desired parameters in a given application.

Suitable tests include green rubber tests, cure tests, and cured rubber tests. Among appropriate green rubber tests, ASTM D4483 sets forth a test method for the ML1+4 Mooney Viscosity test at 100° C. Scorch time is measured according to ASTM D4818.

The curing curve is obtained by Rubber Process Analyzer (RPA2000) at 0.5°, 100 cpm, and 150° C. (NR)-160° C. (SBR) according to ASTM D5289.

Performance characteristics of cured samples can be determined by a series of appropriate tests. Tensile strength, elongation at break, and stress at various strains (e.g. 100% and 300%) are all obtained via ASTM D412 Method A. Dynamic mechanical properties including storage modulus, loss modulus, and tan 8 are obtained by strain sweep test at 10 Hz, 60° C. and various strain amplitudes from 0.1% to 63%. Shore A hardness is measured according to ASTM D2240. Tear strength of die B type cured rubber samples are measured according to ATSM D624.

Undispersed area is calculated by analyzing images obtained by reflection mode optical microscopy for cured rubber compounds of a cut cross-sectional area according to various reported methods. Dispersion can also be represented by the Z value (measured, after reticulation, according to the method described by S. Otto and Al in Kautschuk Gummi Kunststoffe, 58 Jahrgang, NR 7-8/2005, article titled “New Reference value for the description of Filler Dispersion with the Dispergrader 1000 NT”. Standard ISO 11345 sets forth visual methods for the rapid and comparative assessment of the degree of macrodispersion of carbon black and carbon black/silica in rubber.

Abrasion resistance is quantified as an index based on abrasion loss of cured rubber by the Cabot Abrader (Lambourn type). Attractive abrasion resistance results can be indicative of advantageous wear properties. Good hysteresis results can be associated with low rolling resistance (and correspondingly higher fuel economy) for motor vehicle tire applications, reduced heat build-up, tire durability, tread life and casing life, fuel economy features for the motor vehicle and so forth.

Iodine number (12 No.) is determined according to ASTM Test Procedure D1510. STSA (statistical thickness surface area) is determined based on ASTM Test Procedure D-5816 (measured by nitrogen adsorption). OAN is determined based on ASTM D2414. COAN is determined based on ASTM D3493 (e.g., D3493-20).

Unless otherwise specified, all material proportions described as a percent herein are in weight percent.

The present invention will be further clarified by the following examples which are intended to be only exemplary in nature.

The present invention includes the following aspects/embodiments/features in any order and/or in any combination:
1. A method for producing a carbon black comprising:
   electrically heating a carrier gas to form a heated carrier gas such that pyrolysis of at least a portion of a carbon black feedstock will occur in a carbon black reactor by contacting said heated carrier gas, wherein the carbon black feedstock comprises at least one first carbon black feedstock and at least one low-yielding carbon black feedstock;
   combining the at least one first carbon black feedstock with said heated carrier gas to form a reaction stream wherein the at least one first carbon black feedstock comprises at least 10 wt. % of the total carbon black feedstock;
   combining downstream at least one low-yielding carbon black feedstock to said reaction stream present to form the carbon black, wherein the at least one low-yielding carbon black feedstock comprises at least 10 wt. % of the total carbon black feedstock; and
   recovering the carbon black in the reaction stream, wherein the first carbon black feedstock is a liquid at room temperature and pressure, and has the following properties:
a Bureau of Mines Correlation Index (BMCI)≥100,
an atomic H:C ratio of ≤1.23, and
a specific gravity >1.02;
and wherein the low-yielding carbon black feedstock has at least one of the following properties:
a Bureau of Mines Correlation Index (BMCI)<100, or
an atomic H:C ratio of >1.23, or
   a specific gravity of ≤1.02, or
is a gas at room temperature and pressure, and
   wherein the at least one low-yielding carbon black feedstock is present in an amount of from 10 wt % to 90 wt %, based on said total carbon black feedstock, and the at least one first carbon black feedstock is present in an amount of from 10 wt % to 90 wt % based on said total carbon black feedstock.
2. A method for producing a carbon black comprising:
   electrically heating a carrier gas to form a heated carrier gas such that pyrolysis of at least a portion of a carbon black feedstock will occur in a carbon black reactor by contacting said heated carrier gas, wherein the carbon black feedstock comprises at least one first carbon black feedstock and at least one low-yielding carbon black feedstock;
   combining the at least one first carbon black feedstock and the at least one low-yielding carbon black feedstock as a blend or as separate additions at a same location or about the same location, with said heated carrier gas to form a reaction stream wherein the at least one first carbon black feedstock comprises at least 10 wt. % of the total carbon black feedstock and the at least one low-yielding carbon black feedstock comprises at least 10 wt. % of the total carbon black feedstock; and
   recovering the carbon black in the reaction stream, wherein the first carbon black feedstock is a liquid at room temperature and pressure, and has the following properties:
a Bureau of Mines Correlation Index (BMCI)≥100,
an atomic H:C ratio of ≤1.23, and
a specific gravity >1.02;
and wherein the low-yielding carbon black feedstock has at least one of the following properties:
a Bureau of Mines Correlation Index (BMCI)<100, or an atomic H:C ratio of >1.23, or
   a specific gravity of ≤1.02, or is a gas at room temperature and pressure, and
   wherein the at least one low-yielding carbon black feedstock is present in an amount of from 10 wt % to 90 wt %, based on said total carbon black feedstock, and the at least one first carbon black feedstock is present in an amount of from 10 wt % to 90 wt % based on said total carbon black feedstock.
3. A method for producing a carbon black comprising:
   electrically heating at least one first carbon black feedstock to form a reaction stream such that pyrolysis of at least a portion of the at least one first carbon black feedstock will occur in a carbon black reactor, wherein the at least one first carbon black feedstock comprises at least 10 wt. % of the total carbon black feedstock;
   combining downstream at least one low-yielding carbon black feedstock to said reaction stream present to form the carbon black, wherein the at least one low-yielding carbon black feedstock comprises at least 10 wt. % of the total carbon black feedstock; and
   recovering the carbon black in the reaction stream, wherein the first carbon black feedstock is a liquid at room temperature and pressure, and has the following properties:
a Bureau of Mines Correlation Index (BMCI)≥100,
an atomic H:C ratio of ≤1.23, and
a specific gravity >1.02;
and wherein the low-yielding carbon black feedstock has at least one of the following properties:
a Bureau of Mines Correlation Index (BMCI)<100, or
an atomic H:C ratio of >1.23, or
   a specific gravity of ≤1.02, or is a gas at room temperature and pressure, and
   wherein the at least one low-yielding carbon black feedstock is present in an amount of from 10 wt % to 90 wt %, based on said total carbon black feedstock, and the at least one first carbon black feedstock is present in an amount of from 10 wt % to 90 wt % based on said total carbon black feedstock.
4. The method of any preceding or following embodiment/feature/aspect, further comprising electrically heating the at least one low-yielding carbon black feedstock.
5. The method of any preceding or following embodiment/feature/aspect, wherein electrically heating the at least one low-yielding carbon black feedstock comprises heating the low-yielding carbon black feedstock to a temperature from 600 to 800° C.
6. The method of any preceding or following embodiment/feature/aspect, further comprising electrically heating at least one of the at least one first carbon black feedstock and the at least one low yielding carbon black feedstock.
7. The method of any preceding or following embodiment/feature/aspect, wherein said electrically heating is achieved with an arc.
8. The method of any preceding or following embodiment/feature/aspect, wherein said electrically heating is achieved with a resistive or an inductive-based heating element.
9. The method of any preceding or following embodiment/feature/aspect, wherein the heating element is magnesium oxide or yttria-stabilized zirconia.
10. The method of any preceding or following embodiment/feature/aspect, wherein said heated carrier gas has a temperature greater than 2000° C.
11. The method of any preceding or following embodiment/feature/aspect, wherein said electrically heating is achieved with an inductive or microwave-based method that prevents direct contact between an electrode and a carrier gas or carbon black feedstock.
12. The method of any preceding or following embodiment/feature/aspect, wherein said electrically heating is achieved with a plasma arc or heating element in direct contact with said carbon black feedstock.
13. The method of any preceding or following embodiment/feature/aspect, wherein the low-yielding carbon black feedstock is at least one of the following:
a) said Bureau of Mines Correlation Index (BMCI)<95, or
b) said gas at room temperature and pressure, or
c) said atomic H:C ratio of >1.3, or
d) said specific gravity≤1.0.
14. The method of any preceding claim, wherein the low-yielding carbon black feedstock has said specific gravity of at most 1.02.
15. The method of any preceding or following embodiment/feature/aspect, wherein said low-yielding carbon black feedstock is comprises at least one of the following: a vegetable or other plant-derived oil, a bio-sourced ethanol, a plant- or animal-produced wax or resin, an oil rendered from animal fat, an algal oil, an oil rendered from the pyrolysis of sewage sludge or agricultural waste, a byproduct liquid from processing of a biogenic material, a liquid produced by hydrothermal liquefaction of a biomaterial, a crude tall oil, a tall oil rosin, a tall oil pitch, or a tall oil fatty acid, an oil produced from recycled material, an oil derived from the pyrolysis of off-quality, rejected, or end-of-life tires, an oil derived from the pyrolysis of discarded or recycled plastics or rubber products, an oil derived from the pyrolysis of municipal solid waste, or an oil derived from the pyrolysis of biomass, or any combinations thereof.
16. The method of any preceding or following embodiment/feature/aspect, wherein the at least first carbon black feedstock comprises one or more of decant oil, slurry oil, coal tar, a coal tar derivative, ethylene cracker residue, or phenol cracker residue.
17. The method of any preceding or following embodiment/feature/aspect, wherein the first carbon black feedstock is a fraction obtained from distillation of tire pyrolysis oil.
18. The method of any preceding or following embodiment/feature/aspect, wherein the low-yielding carbon black feedstock ranges from 50-90 wt % of a total feedstock input in said method.
19. The method of any preceding or following embodiment/feature/aspect, wherein the low-yielding carbon black feedstock ranges from 60-90 wt % of a total feedstock input in said method.
20. The method of any preceding or following embodiment/feature/aspect, wherein the carbon black reactor has a first chamber wherein said electrically heating occurs and a throat downstream of the first chamber and a reaction chamber downstream of the throat and a quench zone downstream of the reaction chamber, and wherein the first carbon black feedstock is injected in said throat and the low-yielding carbon black feedstock is injected after said throat.
21. The method of any preceding or following embodiment/feature/aspect, wherein said carbon black reaction includes a second throat downstream of said reaction chamber and before said quench zone, and said low-yielding carbon black feedstock is injected in said second throat.
22. The method of any preceding or following embodiment/feature/aspect, wherein said at least one first carbon black feedstock is introduced into said carbon black reactor in a first location and at least one separate location downstream of the first location.
23. The method of any preceding or following embodiment/feature/aspect, wherein the amount of first carbon black feedstock introduced in the first location is greater than 50% of the total amount of the first carbon black feedstock.
24. The method of any preceding or following embodiment/feature/aspect, wherein said at least one low-yielding carbon black feedstock is introduced into said carbon black reactor in at least two separate locations, with one of the separate locations being downstream of the other.
25. The method of any preceding or following embodiment/feature/aspect, wherein said at least one first carbon black feedstock is a blend that comprises less than 50 wt % of a non-high yielding carbon black feedstock based on total weight of said first carbon black feedstock.
26. The method of any preceding or following embodiment/feature/aspect, wherein said at least one first carbon black feedstock is a blend that comprises less than 5 wt % of a low-yielding carbon black feedstock based on total weight of said first carbon black feedstock.
27. The method of any preceding or following embodiment/feature/aspect, wherein said at least one low-yielding carbon black feedstock is a blend that comprises less than 50 wt % of a high yielding black feedstock based on total weight of said low-yielding carbon black feedstock.
28. The method of any preceding or following embodiment/feature/aspect, wherein said at least one low-yielding carbon black feedstock is a blend that comprises less than 5 wt % of a high yielding black feedstock based on total weight of said low-yielding carbon black feedstock.
29. The method of any preceding or following embodiment/feature/aspect, wherein said low-yielding carbon black feedstock has said BMCI of <100.
30. The method of any preceding or following embodiment/feature/aspect, wherein said low-yielding carbon black feedstock has said atomic H:C ratio of >1.23.
31. The method of any preceding or following embodiment/feature/aspect, wherein said low-yielding carbon black feedstock is said gas at room temperature and pressure.
32. The method of any preceding or following embodiment/feature/aspect, wherein said carbon black recovered is a N110, N121, N220, N231, N234, N299, N326, N330, N339, N347, N351, N358, N375, N539, N550, N650, N660, N683, N762, N765, N774, N787, or N990 grade carbon black.
33. Carbon black made from any method of any preceding or following embodiment/feature/aspect,

The present invention can include any combination of these various features or embodiments above and/or below as set forth in any sentences and/or paragraphs herein. Any combination of disclosed features herein is considered part of the present invention and no limitation is intended with respect to combinable features.

The applicant specifically incorporates the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

1. A method for producing a carbon black comprising:
electrically heating a carrier gas to form a heated carrier gas such that pyrolysis of at least a portion of a carbon black feedstock will occur in a carbon black reactor by contacting said heated carrier gas, wherein the carbon black feedstock comprises at least one first carbon black feedstock and at least one low-yielding carbon black feedstock;
combining the at least one first carbon black feedstock with said heated carrier gas to form a reaction stream wherein the at least one first carbon black feedstock comprises at least 10 wt. % of the total carbon black feedstock;
combining downstream at least one low-yielding carbon black feedstock to said reaction stream present to form the carbon black, wherein the at least one low-yielding carbon black feedstock comprises at least 10 wt. % of the total carbon black feedstock; and
recovering the carbon black in the reaction stream, wherein the first carbon black feedstock is a liquid at room temperature and pressure, and has the following properties:
a Bureau of Mines Correlation Index (BMCI)≥100,
an atomic H:C ratio of ≤1.23, and
a specific gravity >1.02;
and wherein the low-yielding carbon black feedstock has at least one of the following properties:
a Bureau of Mines Correlation Index (BMCI)<100, or
an atomic H:C ratio of >1.23, or
a specific gravity of ≤1.02, or
is a gas at room temperature and pressure, and
wherein the at least one low-yielding carbon black feedstock is present in an amount of from 10 wt % to 90 wt %, based on said total carbon black feedstock, and the at least one first carbon black feedstock is present in an amount of from 10 wt % to 90 wt % based on said total carbon black feedstock.

2. A method for producing a carbon black comprising:
electrically heating a carrier gas to form a heated carrier gas such that pyrolysis of at least a portion of a carbon black feedstock will occur in a carbon black reactor by contacting said heated carrier gas, wherein the carbon black feedstock comprises at least one first carbon black feedstock and at least one low-yielding carbon black feedstock;
combining the at least one first carbon black feedstock and the at least one low-yielding carbon black feedstock as a blend or as separate additions at a same location or about the same location, with said heated carrier gas to form a reaction stream wherein the at least one first carbon black feedstock comprises at least 10 wt. % of the total carbon black feedstock and the at least one low-yielding carbon black feedstock comprises at least 10 wt. % of the total carbon black feedstock; and
recovering the carbon black in the reaction stream, wherein the first carbon black feedstock is a liquid at room temperature and pressure, and has the following properties:
a Bureau of Mines Correlation Index (BMCI)≥100,
an atomic H:C ratio of ≤1.23, and
and wherein the low-yielding carbon black feedstock has at least one of the following properties:
a Bureau of Mines Correlation Index (BMCI)<100, or
an atomic H:C ratio of >1.23, or
a specific gravity of ≤1.02, or
is a gas at room temperature and pressure, and
wherein the at least one low-yielding carbon black feedstock is present in an amount of from 10 wt % to 90 wt %, based on said total carbon black feedstock, and the at least one first carbon black feedstock is present in an amount of from 10 wt % to 90 wt % based on said total carbon black feedstock.

3. A method for producing a carbon black comprising:
electrically heating at least one first carbon black feedstock to form a reaction stream such that pyrolysis of at least a portion of the at least one first carbon black feedstock will occur in a carbon black reactor, wherein the at least one first carbon black feedstock comprises at least 10 wt. % of the total carbon black feedstock;
combining downstream at least one low-yielding carbon black feedstock to said reaction stream present to form the carbon black, wherein the at least one low-yielding carbon black feedstock comprises at least 10 wt. % of the total carbon black feedstock; and
recovering the carbon black in the reaction stream, wherein the first carbon black feedstock is a liquid at room temperature and pressure, and has the following properties:
a Bureau of Mines Correlation Index (BMCI)≥100,
an atomic H:C ratio of ≤1.23, and
a specific gravity>1.02;
and wherein the low-yielding carbon black feedstock has at least one of the following properties:
a Bureau of Mines Correlation Index (BMCI)<100, or
an atomic H:C ratio of >1.23, or
a specific gravity of ≤1.02, or
is a gas at room temperature and pressure, and
wherein the at least one low-yielding carbon black feedstock is present in an amount of from 10 wt % to 90 wt %, based on said total carbon black feedstock, and the at least one first carbon black feedstock is present in an amount of from 10 wt % to 90 wt % based on said total carbon black feedstock.

4. The method of claim 1, further comprising electrically heating the at least one low-yielding carbon black feedstock.

5. The method of claim 4, wherein electrically heating the at least one low-yielding carbon black feedstock comprises heating the low-yielding carbon black feedstock to a temperature from 600 to 800° C.

6. The method of claim 1, further comprising electrically heating at least one of the at least one first carbon black feedstock and the at least one low yielding carbon black feedstock.

7. (canceled)

8. (canceled)

9. (canceled)

10. The method of claim 1 wherein said heated carrier gas has a temperature greater than 2000° C.

11. (canceled)

12. (canceled)

13. (canceled)

14. (canceled)

15. The method of claim 1, wherein said low-yielding carbon black feedstock is comprises at least one of the following: a vegetable or other plant-derived oil, a bio-sourced ethanol, a plant- or animal-produced wax or resin, an oil rendered from animal fat, an algal oil, an oil rendered from the pyrolysis of sewage sludge or agricultural waste, a byproduct liquid from processing of a biogenic material, a liquid produced by hydrothermal liquefaction of a biomaterial, a crude tall oil, a tall oil rosin, a tall oil pitch, or a tall oil fatty acid, an oil produced from recycled material, an oil derived from the pyrolysis of off-quality, rejected, or end-of-life tires, an oil derived from the pyrolysis of discarded or recycled plastics or rubber products, an oil derived from the pyrolysis of municipal solid waste, or an oil derived from the pyrolysis of biomass, or any combinations thereof.

16. The method of claim 1, wherein the at least first carbon black feedstock comprises one or more of decant oil, slurry oil, coal tar, a coal tar derivative, ethylene cracker residue, or phenol cracker residue.

17. The method of claim 1, wherein the first carbon black feedstock is a fraction obtained from distillation of tire pyrolysis oil.

18. The method of claim 1, wherein the low-yielding carbon black feedstock ranges from 50-90 wt % of a total feedstock input in said method.

19. (canceled)

20. The method of claim 1, wherein the carbon black reactor has a first chamber wherein said electrically heating occurs and a throat downstream of the first chamber and a reaction chamber downstream of the throat and a quench zone downstream of the reaction chamber, and wherein the first carbon black feedstock is injected in said throat and the low-yielding carbon black feedstock is injected after said throat.

21. The method of claim 20, wherein said carbon black reaction includes a second throat downstream of said reaction chamber and before said quench zone, and said low-yielding carbon black feedstock is injected in said second throat.

22. The method of claim 1, wherein said at least one first carbon black feedstock is introduced into said carbon black reactor in a first location and at least one separate location downstream of the first location.

23. The method of claim 22, wherein the amount of first carbon black feedstock introduced in the first location is greater than 50% of the total amount of the first carbon black feedstock.

24. The method of claim 1, wherein said at least one low-yielding carbon black feedstock is introduced into said carbon black reactor in at least two separate locations, with one of the separate locations being downstream of the other.

25. The method of claim 1, wherein said at least one first carbon black feedstock is a blend that comprises less than 50 wt % of a non-high yielding carbon black feedstock based on total weight of said first carbon black feedstock.

26. The method of claim 1, wherein said at least one first carbon black feedstock is a blend that comprises less than 5 wt % of a low-yielding carbon black feedstock based on total weight of said first carbon black feedstock.

27. The method of claim 1, wherein said at least one low-yielding carbon black feedstock is a blend that comprises less than 50 wt % of a high yielding black feedstock based on total weight of said low-yielding carbon black feedstock.

28. The method of claim 1, wherein said at least one low-yielding carbon black feedstock is a blend that comprises less than 5 wt % of a high yielding black feedstock based on total weight of said low-yielding carbon black feedstock.

29. (canceled)

30. (canceled)

31. (canceled)

32. (canceled)

33. The method of claim 2, further comprising electrically heating the at least one low-yielding carbon black feedstock.

34. The method of claim 33, wherein electrically heating the at least one low-yielding carbon black feedstock comprises heating the low-yielding carbon black feedstock to a temperature from 600 to 800° C.

35. The method of claim 2, further comprising electrically heating at least one of the at least one first carbon black feedstock and the at least one low yielding carbon black feedstock.

36. The method of claim 2, wherein said heated carrier gas has a temperature greater than 2000° C.

37. The method of claim 2, wherein said low-yielding carbon black feedstock is comprises at least one of the following: a vegetable or other plant-derived oil, a bio-sourced ethanol, a plant- or animal-produced wax or resin, an oil rendered from animal fat, an algal oil, an oil rendered from the pyrolysis of sewage sludge or agricultural waste, a byproduct liquid from processing of a biogenic material, a liquid produced by hydrothermal liquefaction of a biomaterial, a crude tall oil, a tall oil rosin, a tall oil pitch, or a tall oil fatty acid, an oil produced from recycled material, an oil derived from the pyrolysis of off-quality, rejected, or end-of-life tires, an oil derived from the pyrolysis of discarded or recycled plastics or rubber products, an oil derived from the pyrolysis of municipal solid waste, or an oil derived from the pyrolysis of biomass, or any combinations thereof.

38. The method of claim 2, wherein the at least first carbon black feedstock comprises one or more of decant oil, slurry oil, coal tar, a coal tar derivative, ethylene cracker residue, or phenol cracker residue.

39. The method of claim 2, wherein the first carbon black feedstock is a fraction obtained from distillation of tire pyrolysis oil.

40. The method of claim 2, wherein the low-yielding carbon black feedstock ranges from 50-90 wt % of a total feedstock input in said method.

41. The method of claim 2, wherein said at least one first carbon black feedstock is a blend that comprises less than 50 wt % of a non-high yielding carbon black feedstock based on total weight of said first carbon black feedstock.

42. The method of claim 2, wherein said at least one first carbon black feedstock is a blend that comprises less than 5 wt % of a low-yielding carbon black feedstock based on total weight of said first carbon black feedstock.

43. The method of claim 2, wherein said at least one low-yielding carbon black feedstock is a blend that comprises less than 50 wt % of a high yielding black feedstock based on total weight of said low-yielding carbon black feedstock.

44. The method of claim 2, wherein said at least one low-yielding carbon black feedstock is a blend that comprises less than 5 wt % of a high yielding black feedstock based on total weight of said low-yielding carbon black feedstock.

45. The method of claim 3, further comprising electrically heating the at least one low-yielding carbon black feedstock.

46. The method of claim 45, wherein electrically heating the at least one low-yielding carbon black feedstock comprises heating the low-yielding carbon black feedstock to a temperature from 600 to 800° C.

47. The method of claim 3, wherein electrically heating comprises electrically heating said heated first carbon black feedstock to a temperature greater than 2000° C.

48. The method of claim 3, wherein said low-yielding carbon black feedstock is comprises at least one of the following: a vegetable or other plant-derived oil, a bio-sourced ethanol, a plant- or animal-produced wax or resin, an oil rendered from animal fat, an algal oil, an oil rendered from the pyrolysis of sewage sludge or agricultural waste, a byproduct liquid from processing of a biogenic material, a liquid produced by hydrothermal liquefaction of a biomaterial, a crude tall oil, a tall oil rosin, a tall oil pitch, or a tall oil fatty acid, an oil produced from recycled material, an oil derived from the pyrolysis of off-quality, rejected, or end-of-life tires, an oil derived from the pyrolysis of discarded or recycled plastics or rubber products, an oil derived from the pyrolysis of municipal solid waste, or an oil derived from the pyrolysis of biomass, or any combinations thereof.

49. The method of claim 3, wherein the at least first carbon black feedstock comprises one or more of decant oil, slurry oil, coal tar, a coal tar derivative, ethylene cracker residue, or phenol cracker residue.

50. The method of claim 3, wherein the first carbon black feedstock is a fraction obtained from distillation of tire pyrolysis oil.

51. The method of claim 3, wherein the low-yielding carbon black feedstock ranges from 50-90 wt % of a total feedstock input in said method.

52. The method of claim 3, wherein the carbon black reactor has a first chamber wherein said electrically heating occurs and a throat downstream of the first chamber and a reaction chamber downstream of the throat and a quench zone downstream of the reaction chamber, and wherein the low-yielding carbon black feedstock is injected after said throat.

53. The method of claim 52, wherein said carbon black reaction includes a second throat downstream of said reaction chamber and before said quench zone, and said low-yielding carbon black feedstock is injected in said second throat.

54. The method of claim 3, further comprising introducing additional first carbon black feedstock to said reaction stream.

55. The method of claim 54, wherein the amount of first carbon black feedstock that is electrically heated to form the reaction stream is greater than 50% of the total amount of first carbon black feedstock.

56. The method of claim 3, wherein said at least one low-yielding carbon black feedstock is introduced into said carbon black reactor in at least two separate locations, with one of the separate locations being downstream of the other.

57. The method of claim 3, wherein said at least one first carbon black feedstock is a blend that comprises less than 50 wt % of a non-high yielding carbon black feedstock based on total weight of said first carbon black feedstock.

58. The method of claim 3, wherein said at least one first carbon black feedstock is a blend that comprises less than 5 wt % of a low-yielding carbon black feedstock based on total weight of said first carbon black feedstock.

59. The method of claim 3, wherein said at least one low-yielding carbon black feedstock is a blend that comprises less than 50 wt % of a high yielding black feedstock based on total weight of said low-yielding carbon black feedstock.

60. The method of claim 3, wherein said at least one low-yielding carbon black feedstock is a blend that comprises less than 5 wt % of a high yielding black feedstock based on total weight of said low-yielding carbon black feedstock.
